(19) United States
(12) Patent Application Publication
(10) Pub. No.: US 2001/0013534 A1
(43) Pub. Date: Aug. 16, 2001

(54) Soldering method and soldering apparatus

(75) Inventors: Hideo Takahashi, Shizuoka-ken (JP); Noboru Yamaguchi, Shizuoka-ken (JP)

Correspondence Address: FINNEGAN, HENDERSON, FARABOW,, GARRETT & DUNNER, L.L.P., 1300 I Street, N.W., Washington, DC, 20005, US

(73) Assignee: YAZAKI CORPORATION

(21) Appl. No.: 09/773,663

(22) Filed: Feb. 2, 2001

(30) Foreign Application Priority Data
Feb. 14, 2000 (JP) 2000-035606

(51) Int. Cl. B23K 1/00; B23K 20/08; B23K 31/02; B23K 35/12

(52) U.S. Cl. 228/178; 228/256; 228/33; 228/37

(57) ABSTRACT

In a soldering method for soldering a thermit case 26 and a pair of bus bars 11a, 19a to be electrically connected to the thermit case 26, a portion to be heated P of the thermit case 26 which is spaced from the respective bus bars 11a, 19a by an approximately equal distance is heated by a gas burner 71, and solders are simultaneously supplied from solder wire supply portions 75a, 75b to a pair of solder joining faces 22 for joining the thermit case 26 and the pair of bus bars 11a, 19a, after the portion to be heated P has been heated. The temperatures of the pair of solder joining faces 22 are made substantially equal to each other by heating the portion to be heated P so that solders are simultaneously supplied to the pair of solder joining faces 22.

### BACKGROUND OF THE INVENTION

1. Field of the Invention

The present invention relates to a soldering method and soldering apparatus which solder a conductive member and a pair of connection terminals to be connected electrically to the conductive member.

2. Description of the Related Art

In connection of electronic parts or constitution of an electronic part, soldering connection has generally been employed in order to connect a terminal and a lead wire to each other. As a conventional soldering method for such a connection of a terminal and a lead wire, there has been known a laser beam or light soldering method which has been disclosed in Japanese Patent Application Laid-Open (JP-A) No. 63-261689.

As shown in FIG. 1, the laser beam soldering method comprises the steps of winding a lead wire 112 on a terminal 110, applying a cream solder 114 to a wound portion 113, applying liquid-like or cream-like light absorbing material 115 with a high light absorption corresponding to the wavelength of the laser beam to a surface of the cream solder 114 or a surface of the terminal 110, and irradiating laser beam 116 to the light absorbing material 115 with a high light absorption to melt the cream solder 114, thereby performing soldering.

In the above-mentioned conventional laser beam soldering method, however, since the light absorbing material 115 is applied to the surface of the cream solder 114, the number of steps for soldering is increases so that that a time for soldering work is made long.

Also, in a system for electrical equipment provided in a vehicle, there has been any circuit breaker which, when any abnormality occurs in a load such as a power window or any abnormality occurs in wire harness constituted by a plurality of wires connecting a battery and respective loads or the like, fuses a large current safety fuse interposed between the battery and the wire harness to cut off the battery and the wire harness from each other thereby preventing the respective loads, the wire harness or the like from burning.

A circuit breaker of this type comprises a connection terminal connected to a battery side, a terminal connected to a load side, and circuit breaking element formed of a conductive member and connected to both the connection terminals electrically, where, when any abnormality occurs in a load or the like, the circuit breaking element serves to cut off both the connection terminals electrically from each other and protect the load or the like.

In such a circuit breaker, in order to solder a circuit breaking element and a pair of connection terminals by the above-mentioned laser beam soldering method, a work for applying cream solder to a pair of solder joining faces of the circuit breaking element and further applying the pair of connection terminals and light absorbing material to the pair of solder joining surface must be performed, so that a working time for soldering is further prolonged.

Also, in a soldering method where solder is supplied to a pair of solder joining surfaces externally, and a circuit breaking element and a pair of connection terminals are soldered to each other, for example, since a portion of one of the connection terminals is heated, the temperatures of the pair of solder joining surfaces tend to become different from each other or uneven. For this reason, it has been difficult to supply solder to a pair of solder joining surfaces to perform simultaneous soldering of both the surfaces.

### SUMMARY OF THE INVENTION

An object of the present invention is to provide a soldering method and soldering apparatus where simultaneous soldering of a pair of solder joining faces is performed while maintaining the pair of solder joining faces at the same or equal temperature, so that the number of working steps can be reduced.

In order to achieve the above object, according to a first aspect of the present invention, there is provided a soldering method which solders a conductive member and a pair of connection terminals to be electrically connected to the conductive member to each other, the method comprising the steps of: heating a portion to be heated of the conductive member, which is spaced from the respective connection terminals by an approximately equal distance, by a heating portion; and supplying solders to a pair of solder joining faces for joining the conductive member and the pair of connection terminals after heating the portion to be heated has been completed.

According to the first aspect, since a portion to be heated of the conductive member which is spaced from the pair of connection terminals by an approximately equal distance is heated by the heating portion, the temperatures of the pair of left and right solder joining surfaces between the conductive member and the pair of connection terminals become equal to each other. For this reason, solder can be supplied via solder wires to the left and right solder joining faces simultaneously, and it is not required to use light absorbing material so that the number of working steps can be reduced.

According to a second aspect of the present invention, the soldering method according to the first aspect further comprises the step of preheating the pair of connection terminals by a preheating portion before the portion to be heated is heated.

According to the second aspect, since the pair of connection terminals are preheated by the preheating portion before the portion to be heated is heated, the temperatures of the conductive member and the pair of connection terminals are suppressed from lowering. For this reason, a sufficient time for solder wire supplying can be secured. Also, since it takes a long time for solidification of the molten solder, bubbles of flux become easy to go out and void formation is suppressed.

According to a third aspect of the present invention, there is provided a soldering apparatus which solders a conductive member and a pair of connection terminals to be electrically connected thereto to each other, comprising: heating means for heating a portion to be heated of the conductive member which is spaced from the respective connection terminals by an approximately equal distance; and solder supply means for simultaneously supplying solder to a pair of solder joining faces for joining the conductive member and the pair of connection terminals after heating the portion to be heated by the heating means has been completed. According to this aspect, effects similar to the first aspect can be obtained.

According to a fourth aspect of the present invention, there is provided a soldering apparatus comprising a pair of connection terminals which comprises a connection terminal connected to a battery side and a connection terminal connected to a load side; a conductive member to be connected to the connection terminals electrically; a circuit breaker having a break portion performing electrical break between the pair of connection terminals by moving or cutting off the conductive member at an abnormal time of a vehicle; heating means which heats a portion to be heated of the conductive member which is spaced from the respective connection terminals by the almost same distance; and solder supply means which supplies solders to a pair of solder joining faces for joining the conductive member and the pair of connection terminals after heating the portion to be heated by the heating means has been completed.

According to the fourth aspect, when a pair of connection terminals and a conductive member in a circuit breaker are soldered, a portion to be heated of the conductive member of the conductive member which is spaced from the respective connection terminals by an approximately equal distance is heated by the heating portion so that the temperatures of the left and right solder joining faces between the conductive member and the pair of connection terminals becomes even or equal to each other. Therefore, effects similar to those in the first aspect can be obtained.

According to a fifth aspect of the present invention, the soldering apparatus according to the third or fourth aspect further comprises preheating means for preheating the pair of connection terminals before the portion to be heated is heated. According to the fifth aspect, effects similar to those in the second aspect can be obtained.

### BRIEF DESCRIPTION OF THE DRAWINGS

FIG. 1 is a configuration diagram showing a conventional laser beam soldering method;

FIG. 2A is a sectional view of a circuit breaker to which a soldering method of an embodiment is applied before the circuit breaker is broken;

FIG. 2B is a top view of the circuit breaker to which the soldering method of the embodiment is applied before the circuit breaker is broken;

FIG. 3 is a configuration diagram of a soldering apparatus of the embodiment;

FIG. 4 is a graph showing temperature rising of a thermit case;

FIG. 5 is a graph showing temperature rising of a bus bar due to preheating; and

FIG. 6 is a graph showing temperature rising of the thermit case and the bus bar due to preheating and main heating.

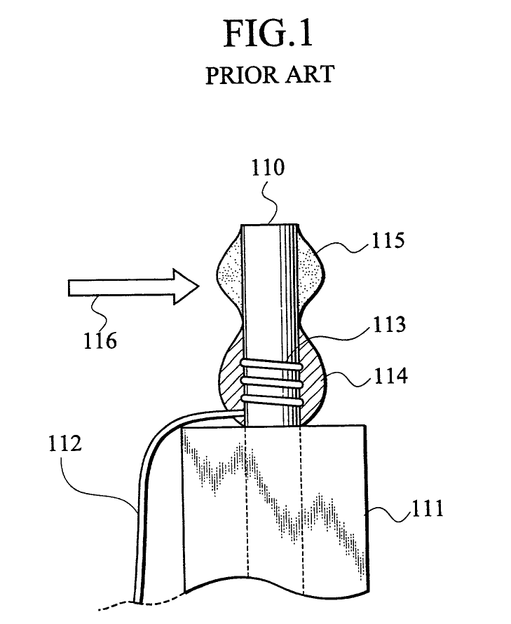

### DETAILED DESCRIPTION OF THE PREFERRED EMODIMENT

An embodiment of a soldering method and a soldering apparatus according to the present invention will be explained below with reference to the drawings. Here, a case will be explained that the soldering method and the soldering apparatus of the embodiment are applied to a circuit breaker for breaking a circuit between a battery and a load at an abnormal time of a vehicle. Incidentally, the soldering method and the soldering apparatus of the embodiment are applicable to apparatuses other than the circuit breaker.

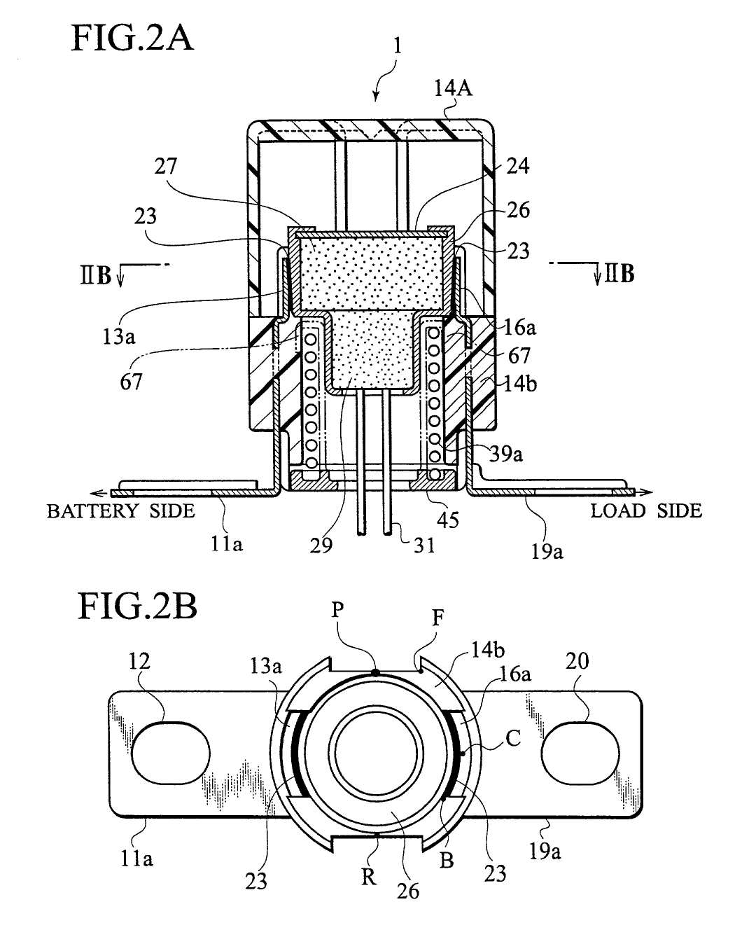

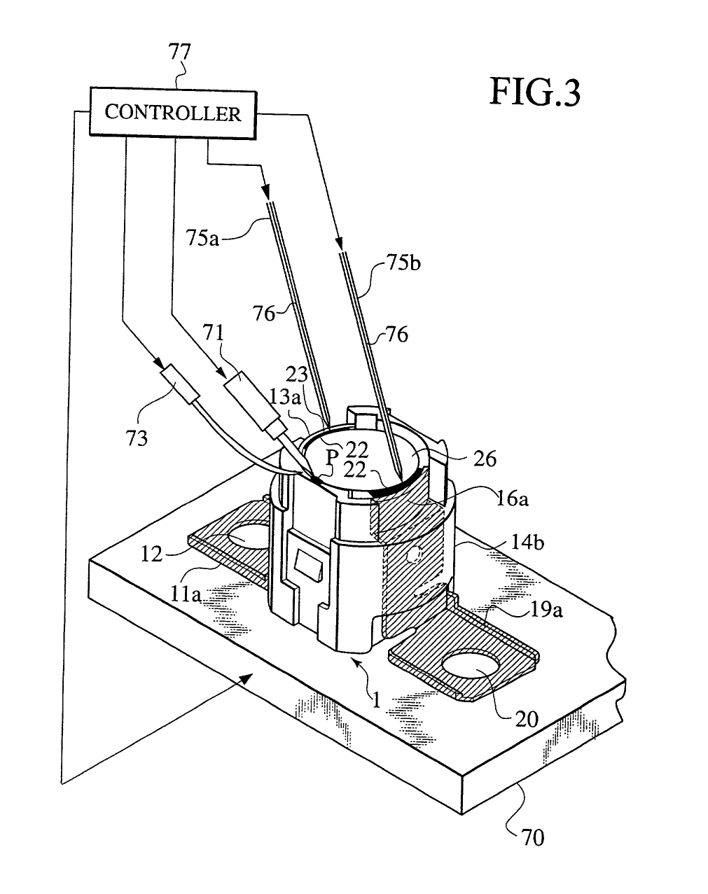

FIG. 2A is a sectional view of a circuit breaker to which a soldering method of the embodiment is applied before the circuit breaker is broken, and FIG. 2B is a top view of the circuit breaker to which the soldering method of the embodiment is applied before the circuit breaker is broken. FIG. 3 is a configuration diagram of a soldering apparatus of the embodiment.

The soldering apparatus shown in FIG. 3 comprises a circuit breaker 1 for breaking or cutting off a circuit between a battery and a load at an abnormal time of a vehicle, a heating stand 70, a gas burner 71, an ignition portion 73, a solder wire supplying portions 75a, 75b, and a controller 77 for controlling the respective portions.

The circuit breaker 1 is disposed on the heating stand 70, and it includes first and second plate-shaped bus bars 11a, 19a formed of copper, copper alloy or the like, a resin case 14b, and a thermit case 26.

The first bus bar 11a has a circular hole portion 12, and it is connected to a battery (not shown) via the circular hole portion 12. The second bus bar 19a has a circular hole portion 20, and it is connected to a load (not shown) via the circular hole portion 20.

The first and second bus bars 11a, 19a are bent upwardly generally at a right angle, and the bent portions are inserted into the resin case 14b and they are formed at their distal end portions with bus bar distal end portions 13a, 16a. The thermit case 26 formed in a cylindrical shape is accommodated in the resin case 14b.

Solders 76 have been supplied to solder joining faces 22, which are paired with the bus bar distal end portions 13a, 16a and the thermit case 26, to solder them. Thus, soldered portions 23 have been formed. The first bus bar 11a and the second bus bar 19a are electrically connectable to each other via the soldered portions 23 and the thermit case 26.

Also, the gas burner 71 heats a portion to be heated P of the thermit case 26 which is separated from the respective bus bars 11a, 19a by an approximately equal distance under control of the controller 77 in order to solder the bus bar distal end portions 13a, 16a and the thermit case 26. In FIG. 2B, a portions of the thermit case 26 are respectively named as a front F, a center C and a back B according to the order departing from a portion nearest to the portion to be heated P, and a portion of the thermit case 26 which is opposed to the portion to be heated P is named as a rear R.

The ignition portion 73 ignites the gas burner 71 by igniting agent under control of the controller 77. The solder wire supplying portions 75a, 75b are structured so as to supply solder under control of the controller 77, so that they simultaneously supply solders 76 such as wire solders to a pair of solder joining faces 22 for joining the thermit case 26 and the pair of bus bar 11a, 19a, after the portion to be heated P has been heated.

The heating stand 70 may be a hot plate or the like, and it preheats the first and second bus bars 11a, 19a and the thermit case 26 provided on the circuit breaker 1 under control of the controller 77 prior to main heating.

Also, as shown in FIG. 2A, a cap 14a is fitted on the resin case 14b. Each of the cap 14a and the resin case 14b is made from insulating material such as resin (thermoplastic resin).

Furthermore, heating agent 27 and an ignition portion 29 connected with lead wires 31 are accommodated in the thermit case 26, and an upper lid 24 is placed on the heating agent. It is preferable that material which has a good heat conductivity and does not melt by heat generation of the heating agent 27, for example, brass, copper, copper alloy, stainless steel, or the like, is used for the thermit case 26. The ignition portion 29 includes ignition agent. The ignition portion 29 ignites the ignition agent by heat generated due to current flowing in the lead wires 31 at an abnormal time of a vehicle such as a vehicle collision or the like, and generates thermit reaction heat at the heating agent 27.

The heating agent 27 is composed of, for example, metal oxide powder such as iron oxide (Fe₂O₃) or the like and aluminum powder, and it is thermit agent for generating high temperature by thermit reaction due to heat generation of the lead wires 31. The thermit agent is sealed in the thermit case 26 which is a metal container for moisture-proof. Incidentally, chromium oxide (Cr₂O₃), manganese oxide (MnO₂) or the like may be used instead of iron oxide (Fe₂O₃).

Mixture of at least one metal powder selected from the group of B, Sn, FeSi, Zr, Ti and Al, at least one metal oxide selected from the group of CuO, MnO₂, Pb₃O₄, PbO₂, Fe₃O₄ and Fe₂O₃, and at least one additive such as alumina, bentonite, talc or the like may be used as the heating agent 27.

Also, a retainer 45 made of a resin member is disposed in the resin case 14b and at a lower portion of the thermit case 26. The retainer 45 serves to retain a compression spring in its compressed state and it is detachably fitted to the resin case 14b. When the retainer 45 is fitted to the resin case 14b, it is disposed in the vicinity of the thermit case 26 or in contact with the same, and it constitutes an attaching/detaching member which is melt due to heat of the heating agent 27. The retainer 45 has a pair of retainer engaging portions 67 engaged with the resin case 14b.

Next, a soldering method for soldering the thermit case 26 and the first and second bus bars 11a, 19a will be explained which is implemented in the soldering apparatus.

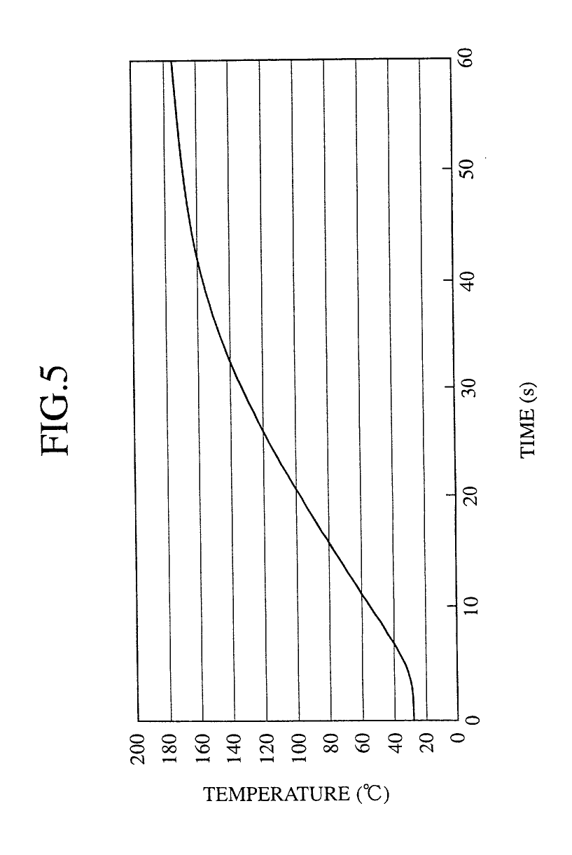

First of all, prior to main heating performed by the gas burner 71, the pair of bus bars 11a, 19a and the thermit case 26 are preheated by the heating stand 70 such as a hot plate. FIG. 5 shows temperature rising of a bus bar generated by preheating. As shown in FIG. 5, the temperature of the bus bar rises according to time elapse and it rises up to about 150° C. for about 40 seconds from a time of heating start. An optimal time for preheating is about 40 seconds.

Next, the gas burner 71 is ignited by the ignition portion 73, the portion to be heated P which is spaced from the respective bus bars 11a, 19a by an approximately equal distance is heated for a fixed time (for example, four seconds) by the gas burner, and the heating of the portion to be heated P is completed.

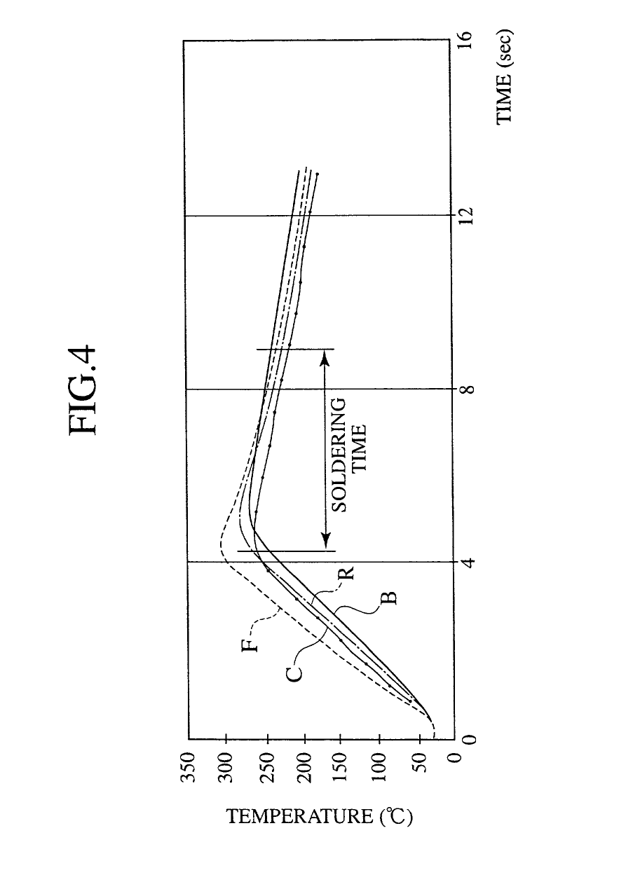

FIG. 4 shows temperature rising of a thermit case. Temperature risings of respective portions of the front F, center C, back B and rear R are shown in FIG. 4. As shown in FIG. 4, the front F nearest to the portion to be heated P is elevated to the highest temperature. In this case, the temperature of the front F is elevated from a heating start for about four seconds and then is lowered gradually.

Next, after the heating of the portion to be heated P has been completed, solders 76 are simultaneously supplied from the solder wire supplying portions 75a, 75b to a pair of solder joining faces 22 for joining the thermit case 26 and the pair of bus bars 11a, 19a. Thereby, the thermit case 26 and the pair of bus bars 11a, 19a are soldered to each other so that soldered portions 23 are formed. As shown in FIG. 4, an optimal time for soldering is about 4.5 to 9 seconds from a heating start time.

That is, since the portion to be heated P which is spaced from the respective bus bars 11a, 19a by the approximately equal distance is heated so that the temperatures of the pair of solder joining faces 22 become approximately equal to each other. Accordingly, the solders 76 can simultaneously be supplied to the pair of solder joining faces 22. Namely, since the pair of solder joining faces 22 can simultaneously be soldered and it is not required to use light absorbing material, the number of working steps can largely be reduced. Also, after completion of heating the thermit case 26, solders 76 are supplied so that flux can be prevented from boiling.

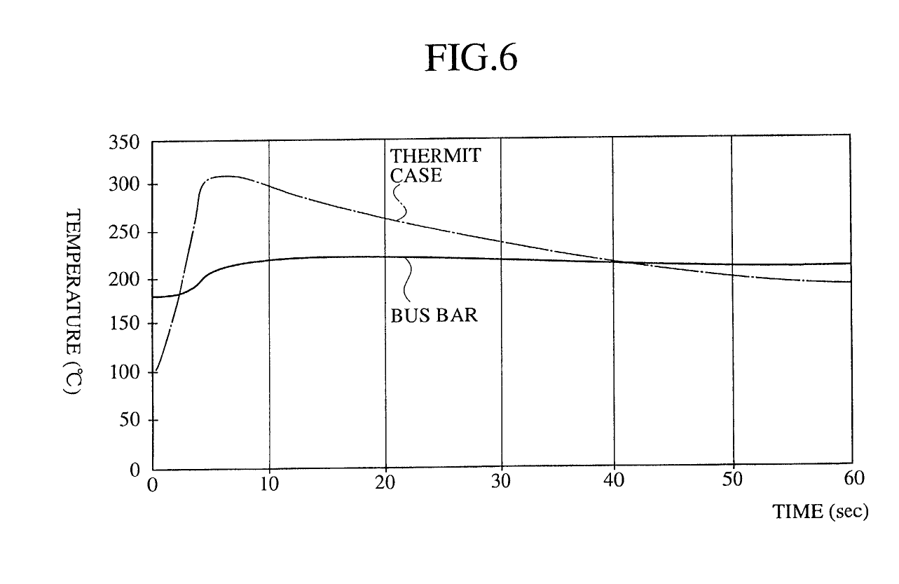

Also, since the first and second bus bars 11a, 19a and the thermit case 26 are preheated by the heating stand 70, the lowering of temperatures of the first and second bus bars 11a, 19a, and the thermit case 26 can be suppressed. FIG. 6 shows temperatures of a thermit case and a bus bar elevated by preheating and main heating. As shown in FIG. 6, the temperatures of the thermit case and the bus bar exceed about 200° C. to be put in a stable state, and they are suitable for solder melting.

Accordingly, a sufficient soldering time can be secured. Also, since a time required for solidification of the solder is prolonged, bobbles of flux are discharged easily from the solder joining faces 22 so that void generation is suppressed.

Furthermore, the circuit breaker 1 is released from the heating stand 70 after about 2 seconds from the completion of solder wire supplying from the solder wire supplying portions 75a, 75b and the portion to be heated P is rapidly cooled by air or the like. That is, by rapid cooling of the portion to be heated P, the solder texture can be prevented from coarsening.

Next, operation of the circuit breaker 1 will be explained with reference to the drawings. First of all, the first bus bar 11a and the second bus bar 19a are electrically connected to each other via the soldered portions 23 and the thermit case 26 in an ordinary situation so that current is supplied from a battery (not shown) to a load (not shown).

Next, when an abnormality occurs in a vehicle, a voltage is applied to the ignition portion 29 via the lead wires 31. Thereby, since the ignition portion 29 is ignited by heat generation due to current, the heating agent 27 which is thermit agent generates thermit reaction heat according to the following reaction formula.

Fe₂O₃+2Al→Al₂O₃+2Fe+386.2 Kcal

The thermit case 26 is heated by the thermit reaction heat, the soldered portions 23 are heated by heat generation of the heating agent 27 and heat of the thermit case 26 to be melted. Also, simultaneously therewith, the resin-made retainer engaging portions 67 for fixing the compression spring 39a to the retainer 45 in a compressed manner are melted. Thereby, since the compression spring 39a is expanded, the thermit case 26 is jumped up towards the cap 14a.

Accordingly, electrical connections of the thermit case 26, the first bus bar 11a and the second bus bar 19a is disconnected. That is, the electrical circuit is broken.

Thus, according to the circuit breaker, the ignition portion 29 is ignited by input of an abnormality signal from a vehicle to cause a thermit reaction at the heating agent 27, and the soldered portions 23 having a low melting point and the retainer engaging portions 67 are melted so that the compression spring 39a is jumped up instantaneously. For this reason, the electrical circuits in the vehicle can securely be broken or cut off in a short time and the electrical parts can be protected.

Incidentally, the present invention is not limited to the soldering method and the soldering apparatus of the embodiment. In the soldering method and the soldering apparatus of the embodiment, the gas burner 71 is used as the heating means for heating the thermit case 26, but laser beam can be used as the heating means.

Also, in the above embodiment, the pair of bus bars 11a, 19a are disconnected electrically by moving the thermit case 26 at an abnormal time of a vehicle. However, for example, such a structure may be employed that such a conductive member as the thermit case 26 or the like is cut off at an abnormal time of a vehicle and the pair of bus bars 11a, 19a are disconnected electrically. In addition, the present invention may be modified and implemented without departing from the scope and spirit of the technical idea of the present invention.

What is claimed is:

1. A soldering method which solders a conductive member and a pair of connection terminals to be electrically connected to the conductive member to each other, the method comprising the steps of:
heating a portion to be heated of the conductive member, which is spaced from the respective connection terminals by an approximately equal distance, by a heating portion; and
supplying solders to a pair of solder joining faces for joining the conductive member and the pair of connection terminals after heating the portion to be heated has been completed.

2. A soldering method according to claim 1, further comprising the step of preheating the pair of connection terminals by a preheating portion before the portion to be heated is heated.

3. A soldering apparatus which solders a conductive member and a pair of connection terminals to be electrically connected thereto to each other, comprising:
heating means for heating a portion to be heated of the conductive member which is spaced from the respective connection terminals by an approximately equal distance; and
solder supply means for simultaneously supplying solders to a pair of solder joining faces for joining the conductive member and the pair of connection terminals after heating the portion to be heated by the heating means has been completed.

4. A soldering apparatus comprising:
a pair of connection terminals which comprises a connection terminal connected to a battery side and a connection terminal connected to a load side;
a conductive member to be connected to the connection terminals electrically;
a circuit breaker having a break portion performing electrical break between the pair of connection terminals by moving or cutting off the conductive member at an abnormal time of a vehicle;
heating means which heats a portion to be heated of the conductive member which is spaced from the respective connection terminals by an approximately equal distance; and
solder supply means which supplies solders to a pair of solder joining faces for joining the conductive member and the pair of connection terminals after heating the portion to be heated by the heating means has been completed.

5. A soldering apparatus according to claim 3, further comprises preheating means for preheating the pair of connection terminals before the portion to be heated is heated.

6. A soldering apparatus according to claim 4, further comprises preheating means for preheating the pair of connection terminals before the portion to be heated is heated.
